(19) United States
(12) Patent Application Publication
(10) Pub. No.: US 2026/0081915 A1
(43) Pub. Date: Mar. 19, 2026

(54) NETWORK ACCESS METHOD, SYSTEM AND TERMINAL DEVICE

(71) Applicant: Shenzhen Reolink Technology Co., Ltd., Shenzhen (CN)

(72) Inventors: Liang Wang, Shenzhen (CN); Xiangzhong Jiao, Shenzhen (CN)

(21) Appl. No.: 19/401,798

(22) Filed: Nov. 26, 2025

(30) Foreign Application Priority Data
Dec. 30, 2024 (CN) 202411992929.7

(51) Int. Cl. H04L 9/40

(52) U.S. Cl. CPC H04L 63/083

(57) ABSTRACT

A network access method, a system and a terminal device are provided by present application. The method includes broadcasting first network message of the network access device, the first network message is used for a terminal device to access a first network of the network access device; receiving authentication information sent by the terminal device through the first network; determining whether the terminal device has passed network access authentication based on the authentication information; and in response that the terminal device passes the network access authentication, sending a second network message to the terminal device through the first network, the second network message is used for the terminal device to access a second network. The method may reduce hardware requirements for terminal devices requiring network configuration and facilitates the reconfiguration of terminal devices.

### FIELD

The present application relates to a field of internet technology, and in particular to a network access method, a system and a terminal device.

### BACKGROUND

With the development of technology, terminal devices have become part of modern home life. For example, a terminal device such as an Internet Protocol Camera (IPC), a smart network light, and a smart network air conditioner have been widely used in people's daily life.

The terminal device connects to a network after configuration. A user may control the terminal device through a control device such as a smartphone, a tablet computer, or a notebook. A prevailing network configuration method involves user entry of the network name and password, upon which the terminal device establishes a connection to a designated network. and the terminal device accesses the network according to the network name and password. Or the user inputs the network name and password on the control device, the control device generates a QR code containing the network name and password, and the terminal device obtains the network name and password by scanning the QR code and then accesses the network. The above network configuration methods have certain hardware requirements for the terminal device, for example, requiring the terminal device to have physical buttons or a touch screen for inputting characters, or a camera for scanning the QR code.

Furthermore, in order to effectively monitor whether a designated area is in a secure status, the IPC is typically installed at an elevated position (for example, under an eave of the area under video surveillance). When the terminal device is abnormal and disconnected from an originally accessed network, or when the password of the network originally accessed by the IPC changes, the user needs to reconfigure the terminal device to access the network according to the above methods. Since the above network configuration methods require operating the terminal device, it is necessary to first dismantle the IPC before reconfiguring it for network recovery. This method of reconfiguration is extremely inconvenient, especially when the terminal device is installed at a high position and is not suitable for direct operation, leading to operational inconvenience.

### SUMMARY

In view of the above problems, embodiments of the present application provide a network access method and system, a network access device and a terminal device, used to solve the problems in the prior art of high hardware requirements for terminal devices needing network configuration and operational inconvenience when a terminal device installed at a high position needs reconfiguration.

In view of the above problems, embodiments of the present application provide a network access method and system, a network access device and a terminal device, used to solve the problems in the prior art of high hardware requirements for terminal devices needing network configuration and operational inconvenience when a terminal device installed at a high position needs reconfiguration.

According to one aspect of the embodiments of the present application, a network access method is provided, applied to a network access device, the method comprising: broadcasting first network message of the network access device, the first network message is used for a terminal device to access a first network of the network access device; receiving authentication information sent by the terminal device through the first network; determining whether the terminal device has passed network access authentication based on the authentication information; and in response that the terminal device passes the network access authentication, sending a second network message to the terminal device through the first network, the second network message is used for the terminal device to access a second network.

In at least one embodiment, the method further comprises: in response to a request for network access authentication for each terminal device, displaying an identification code of each terminal that is stored in the network access device, wherein, the network access device stores authentication information after receiving the authentication information sent by each terminal device, the authentication information comprises the identification code corresponding to the terminal device, and hidden characters of displayed identification code; in response to an operation of selecting an identification code from displayed identification codes, determining whether the authentication information, stored in the network access device corresponding to the identification code selected by the operation, comprises an access password, wherein the access password is a password of the terminal device corresponding to the identification code; in response that the authentication information associated with the selected identification code does not comprise the access password, outputting first prompt information, wherein, the first prompt information is used to prompt for inputting hidden characters of the selected identification code to the network access device; acquiring input characters; determining whether the input characters are the same as the hidden characters of the selected identification code; in response that the input characters are the same as the hidden characters, determining that the terminal device corresponding to the selected identification code passes the network access authentication.

In at least one embodiment, the method further comprises: in response that the authentication information associated with the selected identification code comprises the access password, outputting second prompt information, wherein, the second prompt information is used to prompt for inputting the access password of the terminal device corresponding to the selected identification code to the network access device; acquiring an input access password; determining whether the input access password is the same as the access password of the terminal device corresponding to the selected identification code; in response that the input access password is the same as the access password of the terminal device corresponding to the selected identification code, determining that the terminal device corresponding to the selected identification code passes the network access authentication.

In at least one embodiment, the method further comprises: when the terminal device accesses the first network, determining whether a MAC address of the terminal device belongs to addresses in a first blacklist; in response that the MAC address of the terminal device belongs to the addresses in the first blacklist, disconnecting the first network accessed by the terminal device; in response that the MAC address of the terminal device does not belong to the addresses in the first blacklist, determining whether the terminal device passes network access authentication according to the authentication information of the terminal device.

In at least one embodiment, wherein the first blacklist is updated by: determining whether the authentication information of the terminal device is encrypted; in response that the authentication information is encrypted, determining whether an encryption method of the authentication information is valid; in response that the encryption method of the authentication information is invalid, adding the MAC address of the terminal device to the first blacklist; and/or after the terminal device accesses the first network, in response that the authentication information sent by the terminal device is not received within a first time period, adding the MAC address of the terminal device to the first blacklist.

In at least one embodiment, the method further comprises: in response that the terminal device passes the network access authentication, sending an abnormality request to the terminal device through the first network; receiving abnormality information of the terminal device sent by the terminal device to the network access device according to the abnormality request.

In at least one embodiment, the first network is a public network provided by the network access device, and the second network is a private network provided for network configuration of the terminal device.

In at least one embodiment, the first network message comprises a name of the first network or the first network message comprises the name and a password of the first network, and the second network message comprises a name and a password of the second network.

In at least one embodiment, wherein the network access device is a Network Video Recorder, a network hub, a network router, or an electronic device installed with a network access application.

According to another aspect of the embodiments of the present application, a network access device is provided, comprising a memory, a processor, and a computer program stored on the memory, wherein the processor executes the computer program to implement the network access method described above.

According to another aspect of the embodiments of the present application, a network access method is provided, applied to a terminal device, the method comprising: acquiring a first network message broadcast by a network access device; accessing a first network provided by the network access device through the first network message; sending authentication information of the terminal device to the network access device through the first network, and determining whether the terminal device passes network access authentication by the network access device; in response that the terminal device passes the network access authentication, receiving a second network message sent by the network access device through the first network; accessing a second network according to the second network message.

In at least one embodiment, when first network messages broadcast by a plurality of network access devices simultaneously, the method further comprises: step c1: in response that the second network message sent by a current network access device of the first network currently accessed by the terminal device is not received, repeatedly executing the following steps c2 to c5 until the second network message sent by one of the network access devices is received; step c2: disconnecting the first network connection established with the current network access device; step c3: acquiring first network messages broadcast by other network access devices among the multiple network access devices except the current network access device; step c4: accessing the first network provided by the other network access devices based on the first network messages broadcast by the other network access devices; step c5: sending the authentication information to the network access device with which the terminal device currently has established the first network connection.

In at least one embodiment, the method further comprises: acquiring a MAC address broadcast by the network access device; determining whether the MAC address of the network access device belongs to addresses in a second blacklist; in response that the MAC address of the network access device belongs to the addresses in the second blacklist, not accessing the first network provided by the network access device; in response that the MAC address of the network access device does not belong to the addresses in the second blacklist, accessing the first network provided by the network access device; wherein, the second blacklist is updated by: adding the MAC address of the network access device to the second blacklist in response that a confirmation message sent by the network access device is not received within a second time period, after sending the authentication information of the terminal device to the network access device.

In at least one embodiment, the first network is a public network provided by the network access device, and the second network is a private network provided for network configuration of the terminal device.

In at least one embodiment, the first network message comprises a name of the first network or the first network message comprises the name and a password of the first network, and the second network message comprises a name and a password of the second network.

According to another aspect of the embodiments of the present application, a terminal device is provided, comprising a memory, a processor, and a computer program stored on the memory, wherein the processor executes the computer program to implement the network access method described above.

According to another aspect of the embodiments of the present application, a network access system is provided, the system comprising a network access device and a terminal device, wherein: the network access device is configured to broadcast a first network message of the network access device; the terminal device is configured to acquire the first network message broadcast by the network access device, access the first network of the network access device through the first network message, and send authentication information of the terminal device to the network access device through the first network; the network access device is further configured to receive the authentication information sent by the terminal device, determine whether the terminal device passes network access authentication according to the authentication information, and in response that the terminal device passes the network access authentication, send a second network message to the terminal device through the first network; the terminal device is further configured to receive the second network message sent by the network access device, and access a second network according to the second network message.

In the embodiments of the present application, the network access device broadcasts the first network message to the terminal device, so that the terminal device establishes a first network communication connection with the network access device, and then the network access device can receive the authentication information sent by the terminal device to determine whether the terminal device passes the network access authentication. If the terminal device passes the network access authentication, the network access device sends the second network message to the terminal device, so that the terminal device accesses the second network, thereby completing the network configuration process for the terminal device. In the above network configuration process, there is no need to directly input the second network message (e.g., the name and password of the second network) into the terminal device, nor does the terminal device need to scan a QR code carrying the second network message. Therefore, the hardware requirements for the terminal device are low, meaning that the terminal device does not need to have physical buttons or a touch screen for inputting characters, nor does it need a camera for scanning QR codes, to complete the network configuration of the terminal device.

For situations such as when the terminal device malfunctions and disconnects from the originally accessed second network, or when the configuration information of the second network (e.g., the password of the second network) changes causing the terminal device to be unable to access the second network, the terminal device can be reconfigured for network access according to the network access method provided by the embodiments of the present application. When the terminal device is an IPC and is installed at a high position, it is not necessary to dismantle the IPC to reconfigure it for network access, making the operation convenient.

The above description is only an overview of the technical solutions of the embodiments of the present application. In order to understand the technical means of the embodiments of the present application more clearly, they may be implemented according to the content of the description, and in order to make the above and other objectives, features, and advantages of the embodiments of the present application more apparent and understandable, specific implementations of the present application are listed below.

### BRIEF DESCRIPTION OF THE DRAWINGS

The drawings are used only for showing the implementations and are not to be considered as limiting the present application. Moreover, throughout the drawings, the same reference symbols denote the same parts. In the drawings:

FIG. 1 shows a schematic diagram of an application scenario of a network access method provided by an embodiment of the present application.

FIG. 2 shows a structural schematic diagram of a network access device provided by an embodiment of the present application.

FIG. 3 shows a structural schematic diagram of a terminal device provided by an embodiment of the present application.

FIG. 4 shows a schematic diagram of a network access system provided by an embodiment of the present application.

FIG. 5 shows a flowchart of a network access method provided by an embodiment of the present application.

FIG. 6 shows a flowchart of a method for confirming that a terminal device passes network access authentication provided by an embodiment of the present application.

FIG. 7 shows a schematic diagram of an application scenario of another network access method provided by an embodiment of the present application.

### DETAILED DESCRIPTION

Exemplary embodiments of the present application will be described in more detail below with reference to the accompanying drawings. Although exemplary embodiments of the present application are shown in the drawings, it should be understood that the present application may be implemented in various forms and should not be limited by the embodiments of the present application.

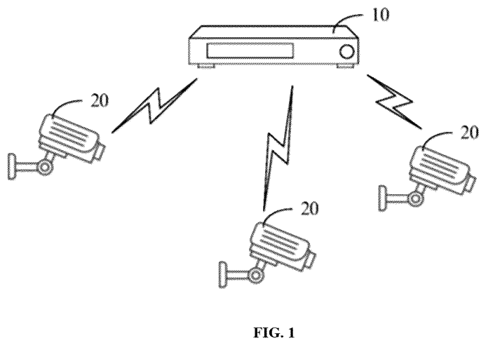

FIG. 1 shows a schematic diagram of an application scenario of a network access method provided by an embodiment of the present application. As shown in FIG. 1, the scenario applying the network access method provided by the embodiment of the present application includes a network access device 10 and a terminal device 20. The network access device 10 may be a Network Video Recorder (NVR), a network router, a network hub, or an electronic device installed with a network access application, etc., which may provide network connections. In this embodiment, the electronic device may create a network hotspot through the network access application, and the network hotspot is a first network of the network access device 10. The terminal device 20 is a device that needs to access the first network, such as an Internet Protocol Camera (IPC), a smart network light, a smart network air conditioner, a smartphone, etc. The terminal device 20 may establish a network connection with the network access device 10 through the network provided by the network access device 10.

It should be noted that FIG. 1 only illustrates one network access device 10 and three terminal devices 20 as an example, and the present application does not limit the number of network access devices 10 and terminal devices 20. In some embodiments, there may also be multiple network access devices 10 and one terminal device 20, or one network access device 10 and one terminal device 20.

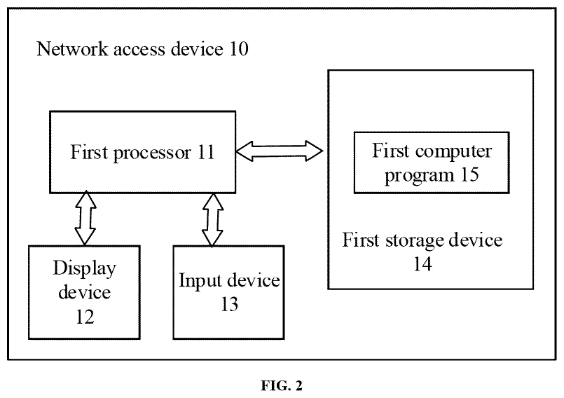

FIG. 2 shows a structural schematic diagram of a network access device provided by an embodiment of the present application. As shown in FIG. 2, the network access device 10 includes a first processor 11, a display device 12, an input device 13, and a first storage device 14.

The first storage device 14 is used for storing a first computer program 15. The first storage device 14 may include a high-speed RAM memory and may also include a non-volatile memory, such as at least one disk memory. The first computer program 15 includes computer-executable instructions.

The first processor 11 is used for executing the first computer program 15 to implement the steps performed by the network access device 10 in the network access method provided by the embodiments of the present application.

The first processor 11 may be a central processing unit (CPU), or an Application Specific Integrated Circuit (ASIC), or one or more integrated circuits configured to implement the embodiments of the present application. The one or more processors included in the network access device 10 may be the same type of processor, such as one or more CPUs, or maybe different types of processors, such as one or more CPUs and one or more ASICs.

The display device 12 is used for displaying characters, and the display device 12 may be a display screen. The input device 13 is used for inputting characters to the network access device 10, such as physical buttons.

In some embodiments, to improve the integration of the network access device 10, the display device 12 and the input device 13 may be a touch screen integrating display and input functions.

FIG. 3 shows a structural schematic diagram of a terminal device provided by an embodiment of the present application. As shown in FIG. 3, the terminal device 20 includes: a second processor 22 and a second storage device 24.

The second storage device 24 is used for storing a second computer program 26. The second storage device 24 may include a high-speed RAM memory and may also include a non-volatile memory, such as at least one disk memory. The second computer program 26 includes computer-executable instructions.

The second processor 22 is used for executing the second computer program 26 to implement the steps performed by the terminal device 20 in the network access method provided by the embodiments of the present application.

The second processor 22 may be a central processing unit (CPU), or an Application Specific Integrated Circuit (ASIC), or one or more integrated circuits configured to implement the embodiments of the present application. The one or more processors included in the terminal device 20 may be the same type of processor, such as one or more CPUs; or maybe different types of processors, such as one or more CPUs and one or more ASICs.

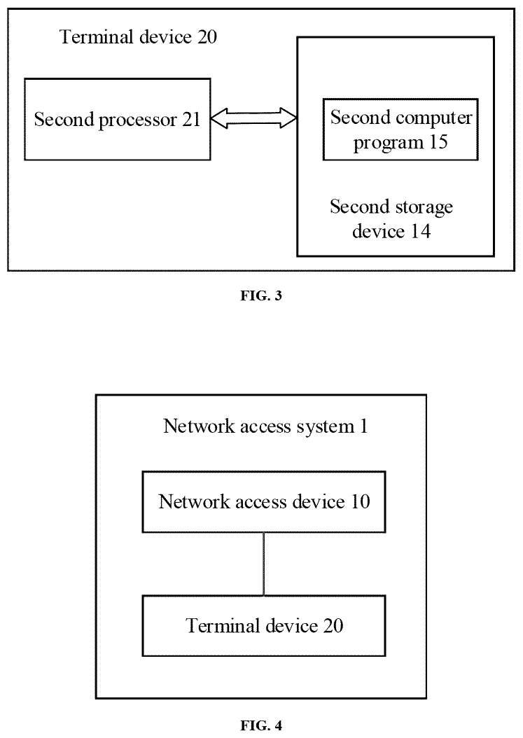

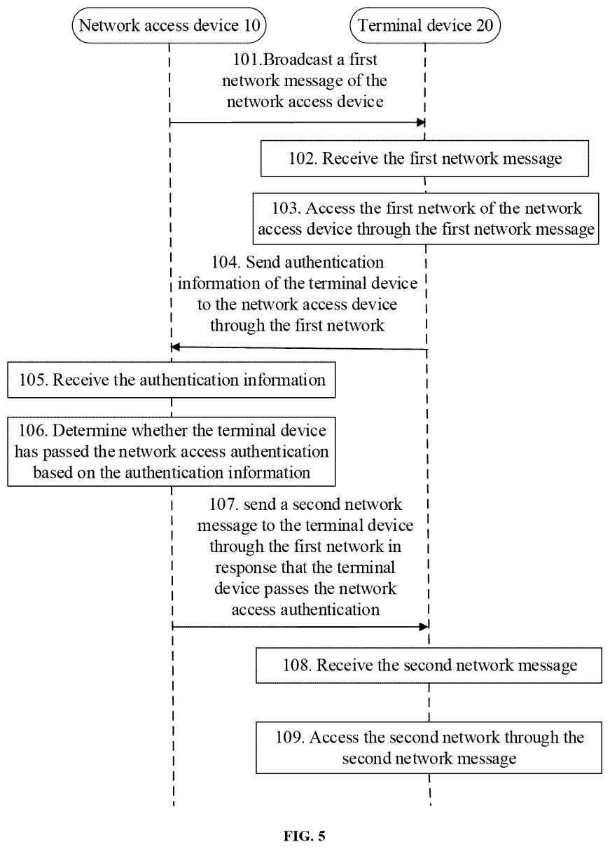

FIG. 4 shows a schematic diagram of a network access system provided by an embodiment of the present application. As shown in FIG. 4, the network access system 1 includes a network access device 10 and a terminal device 20. The network access device 10 is used to perform the steps executed by the network access device 10 in the network access method provided by the embodiments of the present application. The terminal device 20 is used to perform the steps executed by the terminal device 20 in the network access method provided by the embodiments of the present application. In this embodiment, the network access system 1 may include one or more network access devices 10 and one or more terminal devices 20. Multiple terminal devices 20 may access the network through the same network access device 10.

FIG. 5 shows a schematic flowchart of a network access method provided by an embodiment of the present application. As shown in FIG. 5, the method includes the following steps:

Step 101: The network access device 10 broadcasts a first network message of the network access device 10.

The network access device 10 creates a first network. In this embodiment, the first network is a public network (e.g., a wired network or a wireless network) provided by the network access device 10. Terminal devices located within a coverage range of the first network of the network access device 10 may establish a first network connection with the network access device 10. The second network may be a private network provided by the network access device 10 for network configuration of the terminal device 20, for example, the second network may be a wired network or a wireless network or may be a private network provided by other network access devices besides the network access device 10 for network configuration of the terminal device 20. The first network message includes, but is not limited to, a name of the first network, or the name and a password of the first network. The name of the first network is the Service Set Identifier (SSID) of the first network. The password of the first network is a key required for the terminal device 20 to access the first network. In this embodiment, when the network access device 10 is an NVR, a network router, or a network hub, the network access device 10 sends the first network message by periodic broadcasting, so that the terminal device 20 may access the first network of the network access device 10 according to the first network message. When the network access device 10 is a mobile electronic device (e.g., a mobile phone or tablet computer on which a user has downloaded the network access application APP) installed with the network access application APP, the user needs to launch the network access application APP on the mobile electronic device to create a network hotspot, which may be the first network of the network access device 10, so that the terminal device 20 may access the first network established by the mobile electronic device through the network hotspot.

Step 102: the terminal device 20 receives the first network message.

After the network access device 10 broadcasts the first network message, as long as the terminal device 20 is within the network signal coverage of the network access device 10, the terminal device 20 may acquire the first network message broadcast by the network access device 10. For example, the terminal device 20 may acquire the name of the first network or acquire the name and password of the first network.

Step 103: the terminal device 20 accesses the first network of the network access device 10 through the first network message.

For the first network established by the network access device 10, the terminal device 20 may access the first network established by the network access device 10 through the first network message. In the embodiments of the present application, the first network is a publicly accessible network. All network devices capable of receiving the first network message broadcast by the network access device 10 may access the first network established by the network access device 10. Since the first network is a public network, if no network password is set for the first network, the first network message may only include the name of the first network, and then the terminal device 20 may access the first network established by the network access device 10 by using the name of the first network. If a password is set for the first network, the first network message may include the name and password of the first network, and then the terminal device 20 may access the first network established by the network access device 10 by using the name and password of the first network.

It should be noted that, in some embodiments, to ensure the security of data stored in the network access device 10, even though any terminal device may access the first network of the network access device 10 through the broadcasted first network message, the first network is limited to is used for communication between the two parties, for example, as mentioned below, the terminal device 20 sends authentication information to the network access device 10. The terminal device 20 cannot obtain data stored in the network access device 10 through the first network connection, nor can it send video images acquired by the terminal device 20 to the network access device 10 through the first network connection.

Step 104: the terminal device 20 sends authentication information of the terminal device 20 to the network access device 10 through the first network.

The authentication information refers to information used to identify and verify the identity of the terminal device 20. For example, the authentication information may include a Serial Number (SN) of the terminal device 20, a Unique Identifier (UID), or information composed of SN and UID. The authentication information is different for different terminal devices 20. The authentication information is preset in the terminal device 20. After the terminal device 20 accesses the first network established by the network access device 10, the terminal device 20 may communicate with the network access device 10, and then may send the authentication information of the terminal device 20 to the network access device 10.

Step 105: the network access device 10 receives the authentication information sent by the terminal device 20.

The network access device 10 receives the authentication information of the terminal device 20 for subsequent verification of the identity of the terminal device 20 based on the authentication information.

Step 106: the network access device 10 determines whether the terminal device 20 has passed the network access authentication based on the authentication information.

The user may pre-authenticate the terminal device 20 through the network access device 10. If the user has pre-authenticated the terminal device 20 through the network access device 10, the network access device 10 stores the authentication information of an authenticated terminal device 20, and then in this step, the terminal device 20 is a terminal device that has passed the network access authentication.

To better introduce the authenticated terminal device 20, an example where the network access device 10 is an NVR and the terminal device 20 is an IPC will be used for introduction. The IPC captures video images and obtaining video stream by encoding the video images, then sending the video stream to the NVR over the network, and the NVR receives the video stream for recording and storage. After a user purchases an IPC and an NVR, the purchased IPC is connected to the NVR to enable the IPC to transmit the video stream to the NVR. In such a scenario, the user authenticates the IPC (the IPC belonging to the user) on the NVR, and the authenticated IPC is the terminal device 20 that has passed the network access authentication. The user will not authenticate other IPCs that do not belong to the user on their own NVR, so other IPCs that do not belong to the user cannot pass the network access authentication. The network access device 10 determines whether the terminal device 20 has passed the network access authentication by determining whether the authentication information received in step 105 is the same as the stored authentication information of the terminal device 20. If the authentication information received in step 105 is the same as the stored authentication information of the terminal device 20, it is determined that the terminal device 20 passes the network access authentication.

Step 107: in response that the terminal device 20 passes the network access authentication, the network access device 10 sends a second network message to the terminal device 20 through the first network.

The network access device 10 pre-stores the second network message used for network configuration of the terminal device 20. In this embodiment, the second network is a private network provided for network configuration of the terminal device 20. A private network usually provides services for specific user terminals, having a certain degree of security and privacy to ensure that only authorized user terminals and network devices that have passed network access authentication can access the network resources. Since the second network is not publicly exposed, compared to the first network, the second network pays more attention to network security management and access control. Therefore, the network access device 10 only sends the second network message to the terminal device 20 that has passed the network access authentication through the first network, to ensure the security and privacy of the second network. In this embodiment, the second network message includes, but is not limited to, a name and a password of the second network. The name of the second network may be the Service Set Identifier (SSID) of the second network, and the password of the second network is the key required for the terminal device 20 to access the second network.

It is worth noting that the second network may be a network established by the network access device 10, or a local area network established by other devices besides the network access device 10. For example, if the network access device 10 is an NVR and the terminal device 20 is an IPC, the IPC needs to establish a network connection with the NVR to transmit the video stream to the NVR, then the second network may be a private network established by the NVR. Or the network access device 10 is a mobile phone on which the user has downloaded the network access application APP, and the terminal device 20 is an IPC. The IPC needs to establish a network connection with the user's router to store the video stream to a cloud server or to allow the user to remotely view the real-time video stream of the IPC through devices such as a mobile phone. Then the second network may be a local area network created by the user's router. To enable the mobile phone to send the second network message to the IPC, the user may pre-configure the second network message in the mobile phone and. When connecting the router to the network, the user may enable the phone's network hotspot (which serves as the first network) through the network access application APP. At this time, the mobile phone may send the router's second network message to the IPC through the network hotspot.

Step 108: the terminal device 20 receives the second network message sent by the network access device 10.

In some embodiments, after the terminal device 20 receives the second network message sent by the network access device 10, to facilitate subsequent access of the terminal device 20 to the second network using the second network message, the terminal device 20 also stores the second network message (e.g., the name and password of the second network) in the second storage device 24.

It should be noted that, in some embodiments, after the network access device 10 sends the second network message to the terminal device 20, the network access device 10 may actively disconnect the first network connection with the terminal device 20, or the terminal device 20 may actively disconnect the first network connection with the network access device 10. This may save network resource of the network access device 10 and the terminal device 20 and also ensure security of transmitting video data between the network access device 10 and the terminal device 20 only through the second network, thereby avoiding the security risks of transmitting video data between the network access device 10 and the terminal device 20 using the first network.

Step 109: the terminal device 20 accesses the second network according to the second network message.

The terminal device 20 may access the second network through the second network message (e.g., the name and password of the second network).

In the embodiments of the present application, the network access device 10 broadcasts the first network message to the terminal device 20, so that the first network message instructs the terminal device 20 to establish communication with the network access device 10 via the first network, and then the network access device 10 may receive the authentication information sent by the terminal device 20 to determine whether the terminal device 20 passes the network access authentication. In response that the terminal device 20 passes the network access authentication, the network access device 10 sends the second network message to the terminal device 20, so that the terminal device 20 accesses the second network, thereby completing the network configuration process for the terminal device 20. In the above network configuration process, there is no need to directly input the second network message (e.g., the name and password of the second network) into the terminal device 20, nor does the terminal device 20 need to scan a QR code carrying the second network message. Therefore, the hardware requirements for the terminal device 20 are low, and the terminal device 20 does not need to have physical buttons or a touch screen for inputting characters, nor does it need a camera for scanning the QR code, to complete the network configuration of the terminal device 20.

In cases where an abnormality in the terminal device 20 causes it to disconnect from the previously connected second network, or when changes in the configuration information of the second network (such as the password of the second network) prevent the terminal device 20 from accessing the second network, etc. the terminal device 20 may be reconfigured for network access according to the network access method provided by the embodiments of the present application. When the terminal device 20 is an IPC and is installed at a high position, it may be reconfigured for network connection without the need to dismantle it, providing a convenient operation.

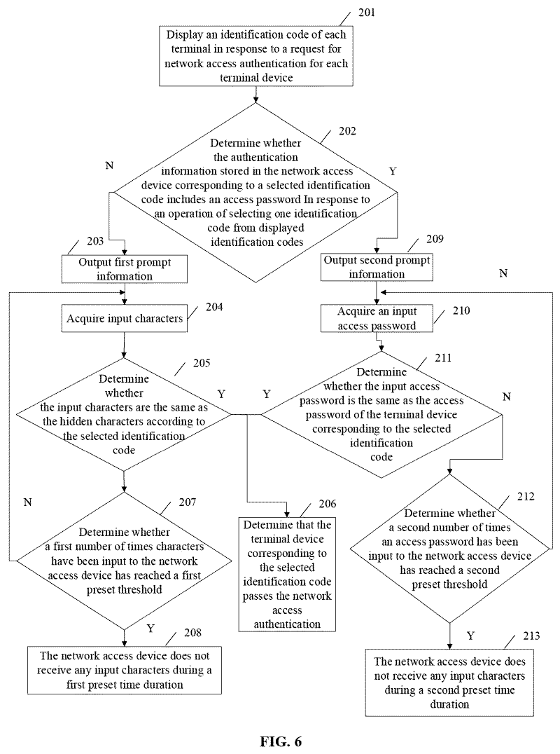

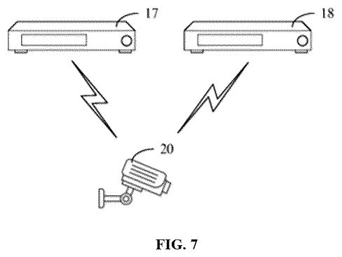

FIG. 6 shows a flowchart illustrating a method for confirming network access authentication of a terminal device according to an embodiment of the present application. This method describes a process, performed by the network access device 10, for authenticating the terminal device 20. As shown in FIG. 6, the process of authenticating the terminal device 20 for network access includes the following steps.

Step 201: In response to a request for network access authentication for each terminal device, the network access device 10 displays an identification code of each terminal.

During the process of executing the embodiment provided in FIG. 5, after the network access device 10 receives the authentication information sent by each terminal device, the network access device 10 stores the authentication information, and the authentication information includes the identification code of the terminal device. The identification code may be a SN of the terminal device 20, the UID of the terminal device 20, or the SN and UID of the terminal device 20. The identification code displayed by the network access device 10 has part of its characters hidden. The hidden characters may not be displayed or may be replaced by specific symbols, such as “*” or “#”, etc.

Specifically, after the terminal device 20, which has established network connection with the network access device 10 through the first network, sends the authentication information to the network access device 10. If the terminal device 20 has not passed the network access authentication, and the terminal device 20 is not an authenticated device. The network access device 10 stores the authentication information sent by the terminal device 20, for example, by storing the authentication information in a list. Different from the authentication information of authenticated terminal devices stored by the network access device 10 involved in step 106, the authentication information stored in the list is used for display in this step. The list of the network access device 10 stores the authentication information of all terminal devices 20 that have established network connection with the network access device 10 through the first network and have sent the authentication information to the network access device 10.

When the user inputs a request for authenticating the terminal device on the network access device 10, for example, when the user clicks a button such as “Add Terminal Device” on a display interface of the network access device 10, the network access device 10 displays part of the characters of each stored identification code in the form of a list on the display device 12. For example, if the identification code is a UID, and the UID has 16 characters, the network access device 10 only displays 14 characters of the UID. Or if the identification code is an SN, and the SN has 18 characters, the network access device 10 only displays 15 characters of the SN. Or if the identification code includes both SN and UID, the network access device 10 only displays the UID or only displays the SN.

Step 202: In response to an operation of selecting an identification code from displayed identification codes, the network access device 10 determines whether the authentication information stored in the network access device 10 corresponding to the identification code selected by the operation, includes an access password. The access password is a password of the terminal device corresponding to the identification code. In response that the authentication information stored in the network access device 10 includes the access password, the method executes step 209. In response that the authentication information stored in the network access device 10 does not include the access password, the method executes step 203.

The access password of the terminal device 20 refers to the password used to access the terminal device 20. Taking the terminal device 20 as an IPC as an example, to ensure security of data stored in the IPC and prevent others from stealing the data, the user may set an access password for the IPC. Only by entering a valid access password into the IPC may the data stored in the IPC be read. Therefore, the identity of the user or device attempting to access the IPC may also be verified through the access password of the terminal device 20, to ensure that only authorized users may access monitoring screen and other data of the IPC.

If the user has set an access password for the terminal device 20, then the authentication information sent by the terminal device 20 to the network access device 10 in step 104 includes the identification code and the access password of the terminal device 20. Correspondingly, the authentication information stored in the list by the network access device 10 includes the identification code and the access password of the terminal device 20. If the user has not set an access password for the terminal device 20, then the authentication information sent by the terminal device 20 to the network access device 10 in step 104 includes the identification code of the terminal device 20 but does not include the access password of the terminal device 20. Then, the authentication information stored in the list by the network access device 10 only includes the identification code of the terminal device 20 and does not include the access password.

Step 203: the network access device 10 outputs first prompt information.

If the user has not set an access password for the terminal device 20 corresponding to the selected identification code, for example, in a case where the user is configuring network for the terminal device 20 for the first time, then the authentication information stored in the list of the network access device 10 does not include the access password of the terminal device 20 corresponding to the selected identification code. At this time, the terminal device 20 is authenticated by verifying the identification code. The network access device 10 outputs the first prompt information to prompt the user to input hidden characters of the selected identification code to the network access device 10. For example, if the identification code is a UID and the UID has 16 characters, the network access device 10 only displays 14 characters of the UID, then the first prompt information is used to prompt the user to input 2 hidden characters. Or if the identification code is an SN, and the SN has 18 characters, the network access device 10 only displays 15 characters of the SN, then the first prompt information is used to prompt the user to input 3 hidden characters. Or if the identification code includes both SN and UID, and the network access device 10 only displays the UID, then the first prompt information is used to prompt the user to input the hidden SN, or if the network access device 10 only displays the SN, then the first prompt information is used to prompt the user to input the hidden UID.

Step 204: the network access device 10 acquires input characters. After the user inputs characters to the network access device 10 according to the first prompt information, the network access device 10 acquires the characters input by the user.

Step 205: the network access device 10 determines whether the input characters are the same as the hidden characters according to the selected identification code. If the input characters are the same as the hidden characters, the method executes step 206; if the input characters are different from the hidden characters, the method executes step 207.

In step 104, since the authentication information sent by the terminal device 20 to the network access device 10 includes a complete identification code, the authentication information stored in the list by the network access device 10 also includes the complete identification code. In this step, the network access device 10 determines whether the characters input by the user into the network access device 10 are the same as the hidden characters of the displayed selected identification code based on the complete identification code stored in the list.

Step 206: the network access device 10 determines that the terminal device 20 corresponding to the selected identification code passes the network access authentication.

Taking the terminal device 20 as an IPC as an example, usually when a manufacturer produces an IPC, they set a unique identification code for each IPC, and the identification code is usually attached to body surface of the IPC in the form of a label, or provided to the user along with the IPC in other forms (such as printed on the packaging box or manual). In one embodiment, the purchaser or user of this IPC (referred to as the authorized user) knows the identification code of the IPC.

Therefore, in the embodiments of the present application, if the characters input by the user into the network access device 10 are the same as the hidden characters, it indicates that the user is an authorized user of the terminal device 20 corresponding to the selected identification code, who has the authority to configure the network for the terminal device 20 corresponding to the selected identification code and to read the data stored in the terminal device 20, and the terminal device 20 corresponding to the selected identification code may be determined as a terminal device that has passed the network access authentication.

Step 207: the network access device 10 determines whether a first number of times characters have been input to the network access device 10 has reached a first preset threshold. If the first number of times characters have been input to the network access device 10 has reached the first preset threshold, the method executes step 208; if the first number of times characters have been input to the network access device 10 has not reached the first preset threshold, the method executes step 204. The first preset threshold may be set as needed, for example, 3 or 5, etc.

Step 208: the network access device 10 does not receive any input characters during a first preset time duration. The network access device 10 does not receive any input characters during the first preset time duration by restricting the operation of inputting characters to the network access device 10 for the first preset time duration. In one embodiment, the network access device 10 restricts the operation of inputting characters to the network access device 10 for the first preset time duration, which may mean that the network access device 10 is in a locked state during the first preset time duration, and the user cannot continue to input characters to the network access device 10. The first preset time duration may be set as needed, for example, 5 minutes, 10 minutes, or 30 minutes, etc. By restricting the operation of inputting characters to the network access device 10, malicious users may be prevented from continuously trying different characters to guess or crack the identification code.

Step 209: the network access device 10 outputs second prompt information.

If the user has set an access password for the terminal device 20 corresponding to the selected identification code, for example, in the case where the user is reconfiguring the network for the terminal device 20. For example, the user usually sets an access password for the terminal device 20 after an initial network configuration. Then the authentication information stored in the list of the network access device 10 includes the access password of the terminal device 20 corresponding to the selected identification code. The terminal device 20 is authenticated by verifying the access password of the terminal device 20. The network access device 10 outputs the second prompt information to prompt the user to input the access password of the terminal device 20 corresponding to the selected identification code to the network access device 10. As introduced earlier, the access password of the terminal device 20 is set by the user for the terminal device 20. Therefore, it can also be verified whether the user attempting to configure the network for the terminal device 20 is an authorized user through the access password of the terminal device 20, thereby avoiding data leakage of the terminal device 20.

Step 210: the network access device 10 acquires an input access password.

Step 211: the network access device 10 determines whether the input access password is the same as the access password of the terminal device corresponding to the selected identification code. If the input access password is the same as the access password of the terminal device, the method executes step 206; if the input access password is different from the access password of the terminal device, the method executes step 212.

Steps 210 to 211 are similar to steps 204 to 205. Therefore, the principles and implementation methods of steps 210 to 211 may refer to steps 204 to 205, and will not be repeated here.

Step 212: the network access device 10 determines whether a second number of times an access password has been input to the network access device 10 has reached a second preset threshold. If the second number of times an access password has been input to the network access device 10 has reached the second preset threshold, the method executes step 213; if the second number of times an access password has been input to the network access device 10 has not reached the second preset threshold, the method executes step 210. The second preset threshold may be set as needed, for example, 3, 5, or 7, etc.

Step 213: the network access device 10 does not receive any input characters during a second preset time duration. Restrict the operation of inputting an access password to the network access device for a second preset time duration. The second preset time duration may be set as needed, for example, 5 minutes, 10 minutes, or 30 minutes, etc.

Steps 212 to 213 are similar to steps 207 to 208. Therefore, the principles and implementation methods of steps 212 to 213 may refer to steps 207 to 208, and will not be repeated here.

In the embodiments of the present application, for the case where the user has not set an access password for the terminal device 20, such as when the user is configuring the network for the terminal device 20 for the first time, only when it is determined that the characters input by the user are the same as the hidden characters of the selected identification code, indicating that the user is an authorized user, the terminal device corresponding to the selected identification code is determined as an authenticated terminal device. This ensures that only verified authorized users may configure the network for the terminal device 20 and access the terminal device 20, maintaining the security of the terminal device 20 and the confidentiality of the data.

As mentioned earlier, the identification code of the terminal device 20 is usually attached to the body surface of the terminal device 20 in the form of a label or provided to the user along with the terminal device 20 in other forms (such as printed on a packaging box or manual). Therefore, there may be situations where the identification code of the terminal device 20 is leaked. To address this situation, in the embodiments of the present application, when the authentication information stored in the network access device 10 includes the access password of the terminal device corresponding to the selected identification code, if the terminal device 20 malfunctions and disconnects from the second network, and the user needs to reconfigure the network for the terminal device 20, the user is required to input the access password of the terminal device to the network access device 10. Since the access password of the terminal device 20 is set by the user for the terminal device 20, only when the access password input by the user is the same as the access password in the authentication information stored in the list of the network access device 10, it indicates that the user is an authorized user, and the terminal device corresponding to the selected identification code is determined as an authenticated terminal device. This ensures that only verified authorized users may configure the network for the terminal device 20 and access the terminal device 20, avoiding data leakage of the terminal device 20.

In the embodiments of the present application, to prevent malicious users from continuously trying different characters to guess or crack the identification code or access password, when the number of times the user inputs invalid characters or access password to the network access device 10 exceeds a certain number, the network access device 10 restricts the user from performing the operation of inputting characters or access password to the network access device 10 for a preset time duration, thereby ensuring the security of the terminal device 20 and the confidentiality of its data.

On the basis of the embodiment provided in FIG. 5, in this embodiment of the present application, after step 103, the method further comprises: after the terminal device 20 accesses the first network of the network access device 10, if the network access device 10 does not receive the authentication information sent by the terminal device 20 within the first time duration, the network access device 10 adds a Media Access Control (MAC) address of the terminal device 20 to a first blacklist.

The MAC address is a unique identifier used to identify a network device. Different terminal devices 20 correspond to different MAC addresses. Therefore, after different terminal devices 20 access the first network established by the network access device 10 through the first network message, the network access device 10 may distinguish between different terminal devices 20 through their MAC addresses.

Since terminal devices within the network signal coverage of the network access device 10 may access the first network established by the network access device 10 after receiving the first network message, it is possible that terminal devices that do not need to access the second network also access the first network, causing congestion in the first network and affecting network performance.

To avoid the above situation, in the embodiments of the present application, since a terminal device 20 that needs to access the second network will send the authentication information to the network access device 10 after accessing the first network established by the network access device 10. Therefore, in the embodiments of the present application, if the network access device 10 does not receive authentication information sent by a device that has established network connection with it through the first network within a first time period, it can be determined that the device is not a device that needs to access the second network, and then the MAC address of the device is added to the first blacklist, so as to subsequently manage the devices connected to the first network of the network access device 10 based on the first blacklist. It should be noted that the first time period may be set as needed, for example, 5 minutes, 10 minutes, or 15 minutes, etc.

On the basis of the embodiment provided in FIG. 5, in the embodiment of the present application, after step 105, the method further includes the following steps:

Step a1: the network access device 10 determines whether the authentication information of the terminal device is encrypted. If the authentication information of the terminal device is encrypted, the method executes step a2; if the authentication information of the terminal device is not encrypted, the method executes step a3, and the method does not execute step 106.

Step a2: the network access device 10 determines whether an encryption method of the authentication information is valid. If the encryption method of the authentication information is valid, the method executes step 106; if the encryption method of the authentication information is invalid, the method executes step a3 and does not execute step 106.

When the authentication information of the terminal device 20 is encrypted, the authentication information sent by the terminal device 20 is encrypted authentication information, and the encryption method is pre-stored in the network access device 10.

Step a3: the network access device 10 adds the Media Access Control (MAC) address of the terminal device 20 to the first blacklist.

In the embodiments of the present application, since the authentication information sent by the terminal device 20 that needs to access the second network to the network access device 10 is encrypted information and the encryption method is pre-stored in the network access device 10, after the network access device 10 receives the information sent by the terminal device 20, by determining whether the encryption method of the received information is valid, it may be preliminarily determined whether the terminal device 20 is a device that needs to access the second network. If the authentication information sent by the terminal device to the network access device 10 is not encrypted, or the encryption method does not match the encryption method pre-stored in the network access device 10, it may be determined that this terminal device is not a device that needs to access the second network. Therefore, the network access device 10 does not execute step 106 and adds the MAC address of the terminal device to the first blacklist, so as to subsequently manage the devices connected to the first network of the network access device 10 based on the first blacklist.

In some embodiments, the network access method further includes the following steps:

Step b1: When the terminal device 20 establishes a first network connection with the network access device 10, the network access device 10 determines whether the MAC address of the terminal device 20 belongs to addresses in the first blacklist. If the MAC address of the terminal device 20 belongs to addresses in the first blacklist, the method executes step b2; if the MAC address of the terminal device 20 does not belong to addresses in the first blacklist, the method executes step 105.

After the terminal device 20 accesses the first network established by the network access device 10, the network access device 10 may obtain the MAC address of the terminal device 20, and then determine whether the MAC address of the terminal device 20 belongs to addresses in the first blacklist.

Step b2: the network access device 10 disconnects from the first network connection established by the terminal device 20.

Since the first blacklist stores the MAC addresses of terminal devices that do not need to access the second network, in the embodiments of the present application, after determining that the MAC address of the terminal device 20 belongs to an address in the first blacklist, the network access device 10 disconnects the first network connection with the terminal device 20, thereby avoiding congestion in the first network and improving the performance of the first network.

When the terminal device 20 malfunctions, in order to determine a cause of the malfunction of the terminal device 20, in the embodiment of the present application, on the basis of the embodiment provided in FIG. 5, after step 106, the method further includes: if the terminal device 20 passes the network access authentication, the network access device 10 sends an abnormality request to the terminal device 20 through the first network, and receives abnormality information of the terminal device 20 sent by the terminal device 20 to the network access device 10 according to the abnormality request.

If at a historical moment, the network access device 10 has already sent the second network message to the terminal device 20, and the terminal device 20 again accesses the first network established by the network access device 10 through the first network message broadcast by the network access device 10, it indicates that the terminal device 20 has experienced an abnormality. Therefore, in the embodiments of the present application, the network access device 10 sends a request message to the terminal device 20 and obtains the abnormal information sent by the terminal device 20. This allows network access device 10 to determine the cause of the abnormality in terminal device 20 based on the abnormal information, so that the user may handle the abnormality according to the cause of the abnormality and prevent terminal device 20 from experiencing the same issue again.

FIG. 7 shows a schematic diagram of an application scenario of another network access method provided by an embodiment of the present application. As shown in FIG. 7, the scenario applying the network access method provided by the present application includes multiple network access devices set as wireless network access points and a terminal device 20. The multiple network access devices include a first network access device 17 and a second network access device 18. It should be noted that FIG. 7 only illustrates two network access devices and one terminal device 20 as an example, and the embodiments of the present application do not limit the number of network access devices and terminal devices 20. In some embodiments, there may also be three or more network access devices and one terminal device 20, or three or more network access devices and two or more terminal devices 20.

The first network access device 17 and the second network access device 18 are devices used for broadcasting first network messages. The first network messages broadcast by the first network access device 17 and the second network access device 18 may be the same or different. In the embodiments of the present application, the terminal device 20 may receive the first network message broadcast by the first network access device 17 and access the first network established by the first network access device 17. The terminal device 20 may also receive the first network message broadcast by the second network access device 18 and access the first network established by the second network access device 18.

To better understand the above application scenario, an example where the first network access device 17 is a first NVR, the second network access device 18 is a second NVR, and the terminal device 20 is an IPC will be used for introduction. The first NVR and the IPC belong to user A, and user A needs to establish a second network connection between the first NVR and the IPC, so that the IPC may store the video stream to the first NVR. The second NVR belongs to user B.

In one embodiment, the IPC should establish the second network connection with the first NVR, not with the second NVR. However, if the IPC always establishes the first network connection with the second NVR and does not establish the first network connection with the first NVR, then the IPC will not obtain the name and password of the second network sent by the first NVR, and thus may not establish the second network connection with the first NVR.

Therefore, to solve the above problem, on the basis of the embodiment provided in FIG. 5, in the embodiment of the present application, after step 104, the method further includes the following steps:

Step c1: If the terminal device 20 does not receive the second network message sent by a current network access device of the first network currently accessed by the terminal device 20, the terminal device 20 repeatedly executes the following steps c2 to c5 until the terminal device 20 receives the second network message sent by one of the multiple network access devices.

Specifically, after the terminal device 20 establishes the first network connection with a network access device, if the terminal device 20 does not receive the second network message sent by the network access device, the terminal device 20 repeatedly executes the following steps c2 to c5. For example, if the terminal device 20 currently establishes the first network connection with the second network access device 18, but the terminal device 20 does not receive the second network message sent by the second network access device 18, the terminal device 20 repeatedly executes the following steps c2 to c5.

Step c2: the terminal device 20 disconnects from the first network that the terminal device 20 is currently connected to via the first network connection.

The current network access device is a device among the multiple network access devices that currently has established the first network connection with the terminal device. For example, if the terminal device 20 currently establishes the first network connection with the second network access device 18, then in the step c2, the current network access device is the second network access device 18.

Step c3: the terminal device 20 acquires first network messages broadcast by other network access devices among the multiple network access devices except the current network access device.

The other network access devices refer to the other network access devices among the multiple network access devices except the current network access device in step c2. To better introduce the other network access devices, take the multiple network access devices including the first network access device 17 and the second network access device 18 as an example. For example, if in step c1 the terminal device 20 establishes the first network connection with the second network access device 18 and currently does not receive the second network message sent by the second network access device 18, then in step c2 the current network access device is the second network access device 18, and in this step, the other network access device is the first network access device 17. If the multiple network access devices include three or more network access devices, and so on, which will not be repeated here.

Step c4: the terminal device 20 accesses the first network provided by the other network access devices based on the first network messages broadcast by the other network access devices.

If the terminal device 20 acquires the first network message broadcast by the first network access device 17 in step c3, then in this step, the terminal device 20 establishes the first network connection with the first network access device 17 and sends the authentication information of the terminal device 20 to the first network access device 17.

Step c5: send the authentication information to the network access device with which the terminal device 20 currently has established the first network connection.

The current network access device in this step is not the same as the current network access device in step c2. The current network access device in this step refers to the network access device with which the terminal device 20 establishes a first network connection in step c4. For example, if in step c4, the terminal device 20 establishes a first network connection with the first network access device 17, then the current network access device in this step is the first network access device 17, and the authentication information is sent to the first network access device 17.

In the embodiments of the present application, when there are multiple network access devices broadcasting first network messages simultaneously, the above method may avoid the situation where the terminal device 20 always establishes a first network connection with one of the network access devices, resulting in failure to receive the second network message sent by the network access device that actually needs to configure the network for the terminal device 20, thereby ensuring the completion of network configuration for the terminal device 20.

On the basis of the foregoing embodiments, in the embodiment of the present application, after step 104, the method further includes: if the terminal device 20 does not receive a confirmation message sent by the network access device 10 within a second time period, adding the MAC address of the network access device 10 to a second blacklist. The first network message broadcast by the network access device 10 also includes the MAC address of the network access device 10. In one embodiment, when the network access device 10 broadcasts the name and password of the first network, it also broadcasts the MAC address of the network access device 10 simultaneously. Therefore, when the terminal device 20 acquires the name and password of the first network broadcast by the network access device 10, it also acquires the MAC address of the network access device 10.

As mentioned earlier, each network device corresponds to a unique MAC address. In one embodiment, the network access device 10 also corresponds to a MAC address. For a network access device 10 that needs to send the second network message to the terminal device 20, i.e., the network access device 10 that needs to configure the network for the terminal device 20, after receiving the authentication information sent by the terminal device 20, it will send a confirmation message to the terminal device 20 to confirm that the network access device 10 has received the authentication information sent by the terminal device 20. For a network access device 10 that does not need to send the second network message to the terminal device 20, after receiving the authentication information sent by the terminal device 20, it will not send a confirmation message to the terminal device 20. Therefore, the terminal device 20 determines whether the network access device is one that needs to provide the second network message to it, based on whether it has received a confirmation message from that device. For devices that do not need to provide the second network message to the terminal device 20, the MAC addresses of the devices are added to the second blacklist.

For example, user A has an IPC, an NVR, and a router, and both the NVR and the router broadcast first network messages simultaneously. Here, the first network messages broadcast by the NVR and the router may be the same or different, but user A needs to establish a second network connection between the IPC and the NVR. The NVR needs to provide the second network message to the IPC, and after the NVR receives the authentication information sent by the IPC, the NVR will send a confirmation message to the IPC. If the IPC establishes a first network connection with the router, the IPC cannot obtain the second network message provided by the router, and after the router receives the authentication information sent by the IPC, it will not send a confirmation message to the IPC. Therefore, if the IPC establishes a first network connection with the router and sends authentication information to the router, it will not receive a confirmation message sent by the router. Thus, the IPC may determine that the router does not belong to a network access device that provides it with the second network message, and then add the MAC address of the router to the second blacklist.

In the embodiments of the present application, the terminal device 20 adds the MAC address of the network access device 10 to the second blacklist if it does not receive a confirmation message sent by the network access device 10 within the second time period, so as to subsequently manage the network access devices based on the second blacklist. It should be noted that the second time period may be set as needed, for example, 3 minutes, 5 minutes, or 10 minutes, etc.

In some embodiments, before step 103, the network access method further includes: the terminal device 20 determines whether the MAC address of the network access device 10 is an address in the second blacklist. If the MAC address of the network access device 10 is an address in the second blacklist, the method does not execute step 103; if the MAC address of the network access device 10 is not an address in the second blacklist, the method executes step 103.

In the embodiments of the present application, the first network message broadcast by the network access device 10 also includes the MAC address of the network access device 10. When the network access device 10 broadcasts the first network message, it also broadcasts the MAC address of the network access device 10 simultaneously. Therefore, when the terminal device 20 acquires the first network message broadcast by the network access device 10, it also acquires the MAC address of the network access device 10.

As mentioned earlier, if the MAC address of the network access device 10 belongs to an address in the second blacklist, it indicates that the network access device 10 is a device that does not need to send the second network message to the terminal device 20. Therefore, the terminal device 20 does not establish a first network connection with the network access device 10 and does not send authentication information to the network access device 10, to prevent the leakage of the authentication information of the terminal device 20.

An embodiment of the present application provides a computer-readable storage medium, where the storage medium stores a computer program, and the computer program, when executed by a processor, implements the network access method embodiments described above.

An embodiment of the present application provides a computer program, where the computer program may be executed by a processor to implement the network access method embodiments described above.

An embodiment of the present application provides a computer program product, where the computer program product includes a computer program, and the computer program, when executed by a processor, implements the network access method embodiments described above.

In the several embodiments provided in the present application, any function, if implemented in the form of a software functional module/unit and sold or used as an independent product, may be stored in a computer-readable storage medium. Based on this understanding, the entire or part of the technical solution of the present application may be embodied in the form of a software product. The computer software product is stored in a storage medium and includes several instructions for causing a computer device (which may be a personal computer, a server, or other electronic devices) to perform all or part of the steps of the methods described in the various embodiments of the present application. The aforementioned storage medium includes: a U disk, a mobile hard disk, a Read-Only Memory (ROM), a Random Access Memory (RAM), a magnetic disk, or an optical disk, and other media that may store computer program codes.

The above-described embodiments merely represent several implementation modes of the present application, and the descriptions thereof are specific and detailed, but should not be construed as limiting the scope of the present application. It should be noted that, for those skilled in the art, without departing from the concept of the present application, several modifications and improvements can be made, which all fall within the protection scope of the present application. Therefore, the protection scope of the present application should be determined by the appended claims.

What is claimed is:

1. A network access method, applied to a network access device, the method comprising:
broadcasting a first network message of the network access device, the first network message is used for a terminal device to access a first network of the network access device;
receiving authentication information sent by the terminal device through the first network;
determining whether the terminal device has passed a network access authentication based on the authentication information; and
in response that the terminal device passes the network access authentication, sending a second network message to the terminal device through the first network, the second network message is used for the terminal device to access a second network.

2. The network access method according to claim 1, further comprising:
in response to a request for a network access authentication for each terminal device, displaying an identification code of each terminal that is stored in the network access device, wherein, the network access device stores authentication information after receiving the authentication information sent by each terminal device, the authentication information comprises the identification code corresponding to the terminal device, and hidden characters of a displayed identification code;
in response to an operation of selecting an identification code from displayed identification codes, determining whether the authentication information, stored in the network access device corresponding to the identification code selected by the operation, comprises an access password, wherein the access password is a password of the terminal device corresponding to the identification code;
in response that the authentication information associated with the selected identification code does not comprise the access password, outputting first prompt information, wherein the first prompt information is used to prompt for inputting hidden characters of the selected identification code to the network access device.

3. The network access method according to claim 2, further comprising:
acquiring input characters;
determining whether the input characters are the same as the hidden characters of the selected identification code;
in response that the input characters are the same as the hidden characters, determining that the terminal device corresponding to the selected identification code passes the network access authentication.

4. The network access method according to claim 2, further comprising:
in response that the authentication information associated with the selected identification code comprises the access password, outputting second prompt information, wherein the second prompt information is used to prompt for inputting the access password of the terminal device corresponding to the selected identification code to the network access device;
acquiring an input access password;
determining whether the input access password is the same as the access password of the terminal device corresponding to the selected identification code;
in response that the input access password is the same as the access password of the terminal device corresponding to the selected identification code, determining that the terminal device corresponding to the selected identification code passes the network access authentication.

5. The network access method according to claim 1, further comprising:
when the terminal device accesses the first network, determining whether a Media Access Control MAC address of the terminal device belongs to addresses in a first blacklist;
in response that the MAC address of the terminal device belongs to the addresses in the first blacklist, disconnecting from a first network connection established by the terminal device;
in response that the MAC address of the terminal device does not belong to the addresses in the first blacklist, determining whether the terminal device passes the network access authentication according to the authentication information of the terminal device.

6. The network access method according to claim 5, wherein the first blacklist is updated by:
determining whether the authentication information of the terminal device is encrypted;
in response that the authentication information is encrypted, determining whether an encryption method of the authentication information is valid;
in response that the encryption method of the authentication information is invalid, adding the MAC address of the terminal device to the first blacklist; and/or
after the terminal device accesses the first network, in response that the authentication information sent by the terminal device is not received within a first time period, adding the MAC address of the terminal device to the first blacklist.

7. The network access method according to claim 1, further comprising:
in response that the terminal device passes the network access authentication, sending an abnormality request to the terminal device through the first network;
receiving abnormality information of the terminal device sent by the terminal device to the network access device according to the abnormality request.

8. The network access method according to claim 1, wherein the first network is a public network provided by the network access device, and the second network is a private network provided for network configuration of the terminal device.

9. The method according to claim 1, wherein the first network message comprises a name of the first network or the first network message comprises the name and a password of the first network, and the second network message comprises a name and a password of the second network.

10. The network access method according to claim 1, wherein the network access device is a Network Video Recorder, a network hub, a network router, or an electronic device installed with a network access application.

11. A network access device, comprising a storage device, a processor, and a computer program stored on the storage device, wherein the processor executes the computer program to implement the network access method according to claim 1.

12. A network access method, applied to a terminal device, the method comprising:
acquiring a first network message broadcast by a network access device;
accessing a first network provided by the network access device through the first network message;
sending authentication information of the terminal device to the network access device through the first network, and determining whether the terminal device passes a network access authentication by the network access device;
in response that the terminal device passes the network access authentication, receiving a second network message sent by the network access device through the first network;
accessing a second network according to the second network message.

13. The network access method according to claim 11, wherein when first network messages broadcast by a plurality of network access devices simultaneously, the method further comprises:
step c1: in response that the second network message sent by a current network access device of the first network currently accessed by the terminal device is not received, repeatedly executing the following steps c2 to c5 until the second network message sent by one of the network access devices is received;
step c2: disconnecting from the first network that the terminal device is currently connected to via a first network connection;
step c3: acquiring first network messages broadcast by other network access devices among the plurality of the network access devices except the current network access device;
step c4: accessing the first network provided by the other network access devices based on the first network messages broadcast by the other network access devices;
step c5: sending the authentication information to the network access device with which the terminal device currently has established the first network connection.

14. The network access method according to claim 12, further comprising:
acquiring a Media Access Control MAC address broadcast by the network access device;
determining whether the MAC address of the network access device belongs to addresses in a second blacklist;
in response that the MAC address of the network access device belongs to the addresses in the second blacklist, not accessing the first network provided by the network access device;
in response that the MAC address of the network access device does not belong to the addresses in the second blacklist, accessing the first network provided by the network access device.

15. The network access method according to claim 12, further comprising: wherein the second blacklist is updated by:
adding the MAC address of the network access device to the second blacklist in response that a confirmation message sent by the network access device is not received within a second time period, after sending the authentication information of the terminal device to the network access device.

16. The network access method according to claim 12, wherein the first network is a public network provided by the network access device, and the second network is a private network provided for network configuration of the terminal device.

17. The network access method according to claim 16, wherein the first network message comprises a name of the first network or the first network message comprises the name and a password of the first network, and the second network message comprises a name and a password of the second network.

18. A terminal device, comprising a storage device, a processor, and a computer program stored on the storage device, the processor executes the computer program to implement the network access method according to claim 12.

19. A network access system, the system comprises a network access device and a terminal device, wherein:
the network access device is configured to broadcast a first network message of the network access device;
the terminal device is configured to acquire the first network message broadcast by the network access device, access the first network of the network access device through the first network message, and send authentication information of the terminal device to the network access device through the first network;
the network access device is further configured to receive the authentication information sent by the terminal device, determine whether the terminal device passes network access authentication according to the authentication information, and in response that the terminal device passes the network access authentication, send a second network message to the terminal device through the first network;
the terminal device is further configured to receive the second network message sent by the network access device, and access a second network according to the second network message.

20. The system according to claim 19, wherein the network access device is a Network Video Recorder, a network hub, a network router, or an electronic device installed with a network access application.
